(19) United States
(12) Patent Application Publication
(10) Pub. No.: US 2013/0031225 A1
(43) Pub. Date: Jan. 31, 2013

(54) REMOTELY PRECONFIGURING A COMPUTING DEVICE

(71) Applicant: Ethan Z. Evans, Snoqualmie, WA (US)

(72) Inventor: Ethan Z. Evans, Snoqualmie, WA (US)

(73) Assignee: AMAZON TECHNOLOGIES, INC., Reno, NV (US)

(21) Appl. No.: 13/191,585

(22) Filed: Jul. 27, 2011

(51) Int. Cl. G06Q 30/00; G06F 15/16

(52) U.S. Cl. 709/221; 705/26.5

(57) ABSTRACT

Disclosed are various embodiments for preconfiguring a computing device remotely. A virtualized version of a computing device may be executed remotely and preconfigured by a user. The configuration of the virtualized version of the computing device may then be replicated to a physical version of the computing device. Alternatively, the physical version of the computing device may be executed remotely and preconfigured directly by the user.

### BACKGROUND

Computing devices such as desktop computers, laptops, tablet computers, electronic book readers, smartphones, and so on are typically shipped with a default configuration. In some cases, customers may choose from a variety of hardware and software options which are then used in generating a customized default configuration for a purchased computing device. Nonetheless, customers often spend time customizing and personalizing their computing device after taking possession of it.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is a drawing of a networked environment according to various embodiments of the present disclosure.

FIG. 2 is a drawing of an example of a user interface rendered by a client in the networked environment of FIG. 1 according to various embodiments of the present disclosure.

FIG. 3 is a flowchart illustrating one example of functionality implemented as portions of an electronic commerce application executed in a computing device in the networked environment of FIG. 1 according to various embodiments of the present disclosure.

FIGS. 4A and 4B show a flowchart illustrating one example of functionality implemented as portions of a server application executed in a computing device in the networked environment of FIG. 1 according to various embodiments of the present disclosure.

FIG. 5 is a flowchart illustrating one example of functionality implemented as portions of a remote access application executed in a computing device in the networked environment of FIG. 1 according to various embodiments of the present disclosure.

FIG. 6 is a schematic block diagram that provides one example illustration of a computing device employed in the networked environment of FIG. 1 according to various embodiments of the present disclosure.

### DETAILED DESCRIPTION

The present disclosure relates to preconfiguring a purchased computing device. The options available for customizing software and data installed on a purchased computing device are currently limited. Often, customers spend time customizing and personalizing the computing device after it arrives. Such configuration may not be possible without the customer actually interacting with the computing device. Various embodiments of the present disclosure enable remote interactive preconfiguration of computing devices. In one embodiment, remote interactive access to the actual computing devices is facilitated. In another embodiment, remote interactive access to a virtual computing device is facilitated to allow a customer to personalize and configure the virtual computing device. Subsequently, an actual computing device is preconfigured according to the customized configuration of the virtual computing device. In the following discussion, a general description of the system and its components is provided, followed by a discussion of the operation of the same.

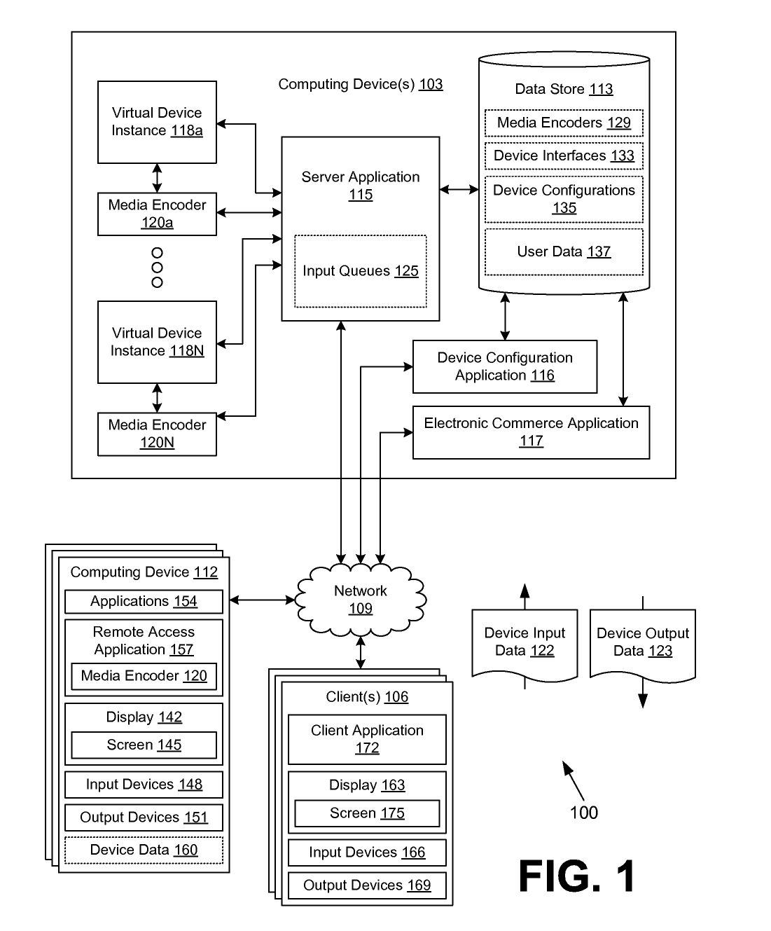

With reference to FIG. 1, shown is a networked environment 100 according to various embodiments. The networked environment 100 includes one or more computing devices 103 in data communication with one or more clients 106 by way of a network 109. In some embodiments, the computing devices 103 and clients 106 may also be in data communication with one or more computing devices 112 by way of the network 109. The network 109 includes, for example, the Internet, intranets, extranets, wide area networks (WANs), local area networks (LANs), wired networks, wireless networks, or other suitable networks, etc., or any combination of two or more such networks.

The computing device 103 may comprise, for example, a server computer or any other system providing computing capability. Alternatively, a plurality of computing devices 103 may be employed that are arranged, for example, in one or more server banks or computer banks or other arrangements. For example, a plurality of computing devices 103 together may comprise a cloud computing resource, a grid computing resource, and/or any other distributed computing arrangement. Such computing devices 103 may be located in a single installation or may be distributed among many different geographical locations. For purposes of convenience, the computing device 103 is referred to herein in the singular. Even though the computing device 103 is referred to in the singular, it is understood that a plurality of computing devices 103 may be employed in the various arrangements as described above.

Various applications and/or other functionality may be executed in the computing device 103 according to various embodiments. Also, various data is stored in a data store 113 that is accessible to the computing device 103. The data store 113 may be representative of a plurality of data stores 113 as can be appreciated. The data stored in the data store 113, for example, is associated with the operation of the various applications and/or functional entities described below.

The components executed on the computing device 103, for example, include a server application 115, a device configuration application 116, an electronic commerce application 117, a plurality of virtual device instances 118a . . . 118N, a plurality of media encoders 120a . . . 120N, and other applications, services, processes, systems, engines, or functionality not discussed in detail herein. In some embodiments, the server application 115 is executed to facilitate interactive remote access to computing devices 112 that have been purchased or may be purchased. The remote access may allow users to preconfigure the computing devices 112 and/or test the operation of the computing devices 112.

In other embodiments, the server application 115 is executed to facilitate interactive remote access to virtual device instances 118 that correspond to virtualized versions of the computing devices 112 that have been purchased or may be purchased. Likewise, users may preconfigure the virtual device instances 118, and configuration changes may be replicated to actual computing devices 112 before the computing devices 112 are shipped. The server application 115 is also executed to obtain device input data 122 from the clients 106 and provide the device input data 122 to the respective virtual device instance 118 or computing device 112.

The server application 115 is also executed to send device output data 123 that is captured from the computing device 112 or virtual device instance 118 to the clients 106. The server application 115 may communicate with the client 106 over various protocols such as, for example, hypertext transfer protocol (HTTP), simple object access protocol (SOAP), representational state transfer (REST), real-time transport protocol (RTP), real time streaming protocol (RTSP), real time messaging protocol (RTMP), user datagram protocol (UDP), transmission control protocol (TCP), and/or other protocols for communicating data over the network 109. The server application 115 is configured to maintain input queues 125 associated with the executing virtual device instances 118 and/or computing devices 112.

In various embodiments, the server application 115 may be configured to generate a user interface using one or more network pages. The network pages may include the streaming video and/or audio generated by the virtual device instance 118. In various embodiments, images of virtual input devices may be rendered in conjunction with the streaming video and/or audio. For example, a virtual keyboard for the virtual device instance 118 or computing device 112 may be included in the network page. Where the computing device 112 is, for example, a mobile computing device, an image of the mobile computing device may be included in the network page. The server application 115 may facilitate interaction with the image of the mobile computing device in conjunction with the virtual device instance 118 and/or the computing device 112. Where the computing device 112 corresponds, for example, to a mobile computing device with a screen, the video captured from the virtual device instance 118 or computing device 112 may be surrounded by the image of the mobile computing device, as if the video were shown on the screen of the mobile computing device.

The device configuration application 116 is executed to implement configuration changes to computing devices 112 and/or virtual device instances 118. In one aspect, the device configuration application 116 may be executed to provide default configurations for computing devices 112 and/or virtual device instances 118. Where users interact with virtual device instances 118, the device configuration application 116 may be executed to store modified configurations of the virtual device instances 118 and replicate the modified configurations to computing devices 112 that have been purchased by the users. Where users interact with computing devices 112 directly, the device configuration application 116 may be executed to replicate a modified configuration of one computing device 112 to another computing device 112. The recipient computing device 112 thereby adopts the modified configuration.

The electronic commerce application 117 is executed in order to facilitate the online purchase of items, such as computing devices 112, applications for the computing devices 112, and so on, from a merchant over the network 109. The electronic commerce application 117 also performs various backend functions associated with the online presence of a merchant in order to facilitate the online purchase of items. For example, the electronic commerce application 117 may generate network pages or portions thereof that are provided to clients 106 for the purposes of selecting items for purchase, rental, download, lease, or other forms of consumption. In some embodiments, the electronic commerce application 117 is associated with a network site that includes an electronic marketplace in which multiple merchants participate.

The virtual device instance 118 corresponds to a virtualized version of the computing device 112. The virtual device instances 118 are preloaded with default configurations, which may then be modified by a user. In various embodiments, the virtual device instance 118 may be configured to provide a virtualized environment for applications by virtualizing one or more of the resources that the applications expect to access. Such resources may include a keyboard, a mouse, a joystick, a video device, a sound device, a global positioning system (GPS) device, an accelerometer, a touchscreen, built-in buttons, a file system, a built-in battery, etc. In this way, the virtual device instance 118 is able to provide input commands and other data to applications if the virtual device instance 118 emulates a keyboard, a mouse, or another type of hardware device.

Further, the virtual device instance 118 is able to obtain a video signal and/or audio signal generated by an operating system application or other applications as if the virtual device instance emulates or simulates a display device, an audio device, or another type of output device. Although many of the examples discussed herein relate to emulated or simulated computing devices with a display, emulated or simulated computing devices may also include, for example, set-top boxes, audio players, and/or other devices without an integrated display screen.

As non-limiting examples, virtual device instances 118 may support applications using different application programming interfaces (APIs) such as OpenGL®, DirectX®, the Graphics Device Interface (GDI), and so on. Where the application is configured for execution in a specialized device or another type of computing device, the virtual device instance 118 may include an emulation application that emulates the device. For example, the output of applications may be captured by the virtual device instance 118 by intercepting system calls, such as drawing calls under a graphics API or other system calls.

One or more media encoders 120 able to encode the video signal and/or audio signal generated from the virtual device instance 118 into a media stream. Various types of media encoders 120 may be used such as, for example, Moving Pictures Experts Group (MPEG) encoders, H.264 encoders, Flash® video encoders, etc. Such media encoders 120 may be selected according to factors such as, for example, data reduction, encoding quality, latency, etc. In some embodiments, the virtual device instances 118 may communicate directly with the clients 106 to obtain the device input data 122 and to serve up the device output data 123.

The input queues 125 may collect input commands from the device input data 122 for a virtual device instance 118. The input commands may be reordered to a correct sequence and delays may be inserted between commands to ensure that they are interpreted correctly when presented to the corresponding virtual device instance 118.

The data stored in the data store 113 includes, for example, media encoders 129, device interfaces 133, device configurations 135, user data 137, and potentially other data. The media encoders 129 correspond to the various types of media encoders 120 that may be employed in the computing device 103 and/or computing device 112. Some media encoders 129 may correspond to specific formats, such as, for example, H.264, MPEG-4, MPEG-2, and/or other formats.

The device interfaces 133 correspond to images, animations, code, hypertext markup language (HTML), extensible markup language (XML), cascading style sheets (CSS), and/or other data that may be used to generate a graphical representation of a virtualized computing device. It is noted that a particular computing device platform may be associated with a multitude of device interfaces 133. As a non-limiting example, the Android® platform for smartphones may be supported by a multitude of different models of smartphones. Some of the models may have mini-keyboards with a touchscreen, while others may have merely a touchscreen with no physical mini-keyboard. The models may have different controls and casings. Therefore, different device interfaces 133 may be provided for different models of Android® smartphones.

Where the computing device 112 does not include an integrated display, the device interface 133 may include a representation of an external display device showing video generated by the computing device 112 or the virtual device instance 118. Similarly, other non-integrated external devices that may connect to the computing device 112 (e.g., keyboards, mice, etc.) may be represented by the device interface 133.

The device configurations 135 correspond to default configurations and user-modified configurations for the computing device 112. Such configurations may include applications and data for the computing device 112. In one embodiment, the device configurations 135 correspond to machine images for the computing device 112. In one embodiment, a device configuration 135 loaded onto and modified by a virtual device instance 118 may then be loaded onto one or more computing devices 112. In some cases, specialized default device configurations 135 may be provided. As a non-limiting example, a school teacher with a reading list may establish a default configuration for an electronic book reader that is preloaded with all of the books on the reading list. Students may be able to configure their electronic book readers individually to adopt that configuration, or the teacher may be able to prompt a mass replication of the default configuration to many electronic book readers at one time (e.g., 100 electronic book readers owned by the school and available for student use.).

The user data 137 may include various data relating to user preferences, order history, user account information, and other data. For example, the user data 137 may indicate status of an order for a computing device 112. Further, the user data 137 may indicate a shipping address where the computing device 112 is to be shipped. If the computing device 112 is to be shipped to a gift recipient, the user data 137 may indicate an address of the gift recipient.

The computing device 112 may comprise, for example, a processor-based system such as a computer system. Such a computer system may be embodied in the form of a desktop computer, a laptop computer, personal digital assistants, cellular telephones, smartphones, set-top boxes, televisions that execute applications and can access the network 109, music players, web pads, tablet computer systems, game consoles, electronic book readers, or other devices with like capability. In one embodiment, the computing devices 112 may be coupled to the network 109 in the networked environment 100 such that remote access may be provided to users who have purchased, or are contemplating purchasing, the computing devices 112. The computing devices 112 may be maintained in the networked environment 100 in a materials handling facility such as a fulfillment center or another facility. Alternatively, the computing devices 112 may be coupled to the networked environment 100 only to replicate a stored device configuration 135 before they are shipped. Ultimately, the computing devices 112 are decoupled from the network 109 and shipped to customers in fulfillment of orders.

The computing device 112 may include a display 142. The display 142 may comprise, for example, one or more devices such as cathode ray tubes (CRTs), liquid crystal display (LCD) screens, gas plasma-based flat panel displays, LCD projectors, or other types of display devices, etc. The display 142 includes a screen 145 that corresponds to the graphical output of the computing device 112 that may be viewed by a user. The computing device 112 may include one or more input devices 148. The input devices 148 may comprise, for example, devices such as keyboards, mice, joysticks, accelerometers, light guns, game controllers, touch pads, touch sticks, push buttons, optical sensors, microphones, webcams, and/or any other devices that can provide user input. Additionally, various input devices 148 may incorporate haptic technologies in order to provide feedback to the user. The computing device 112 may also have various output devices 151 such as, for example, audio devices, indicator lights, vibration devices, haptic devices, and so on.

Various applications and/or other functionality may be executed in the computing device 112 according to various embodiments. The components executed on the computing device 112, for example, include applications 154, a remote access application 157, and other applications, services, processes, systems, engines, or functionality not discussed in detail herein.

The applications 154 correspond to various applications that may be executed in the computing device 112. An application 154 may correspond, for example, to a game or other types of applications. As non-limiting examples, an application 154 may correspond to a first-person shooter game, an action game, an adventure game, a party game, a role-playing game, a simulation game, a strategy game, a vehicle simulation game, and/or other types of games. The applications 154 may be designed for execution in a general-purpose computing device or in a specialized device such as, for example, a smartphone, a video game console, a handheld game device, an arcade game device, etc. The applications 154 may also correspond to mobile phone applications, computer-aided design (CAD) applications, computer-aided manufacturing (CAM) applications, photo manipulation applications, video editing applications, office productivity applications, operating systems and associated applications, emulators for operating systems, architectures, and capabilities not present on a consumer device, and other applications and combinations of applications.

In some embodiments, the remote access application 157 is executed to facilitate remote access to the computing device 112 by way of the network 109. To this end, the remote access application 157 may capture a video signal corresponding to the screen 145 and an audio signal and transmit the signals to the computing device 103 and/or the client 106. In some embodiments, the output of the computing device 112 may be captured by a media encoder 120 of the computing device 103 at a device level. For example, the video output of the computing device 112 may be captured by way of a video graphics array (VGA) connection, a high-definition multimedia interface (HDMI) connection, a component video connection, a national television system committee (NTSC) television connection, and/or other connections. In other embodiments, the remote access application 157 includes one or more media encoders 120 to encode the video signal and/or audio signal captured by software into a media stream.

The remote access application 157 may send the media stream to the client 106 and/or the computing device 103 in the device output data 123. The remote access application 157 may also obtain various data from the client 106 and/or the computing device 103 in the device input data 122. The device input data 122 may correspond to audio signals, input commands, text input, and/or other forms of input data. The computing device 112 may also store various data as device data 160. The device data 160 may include, for example, stored applications 154, photos, videos, audio files, contact data, electronic books, saved text messages, saved voicemails, and/or other data.

The client 106 is representative of a plurality of client devices that may be coupled to the network 109. The clients 106 may be geographically diverse. The client 106 may comprise, for example, a processor-based system such as a computer system. Such a computer system may be embodied in the form of a desktop computer, a laptop computer, personal digital assistants, cellular telephones, smartphones, set-top boxes, televisions that execute applications and can access the network 109, music players, web pads, tablet computer systems, game consoles, electronic book readers, or other devices with like capability.

The client 106 may include a display 163. The display 163 may comprise, for example, one or more devices such as cathode ray tubes (CRTs), liquid crystal display (LCD) screens, gas plasma-based flat panel displays, LCD projectors, or other types of display devices, etc. The client 106 may include one or more input devices 166. The input devices 166 may comprise, for example, devices such as keyboards, mice, joysticks, accelerometers, light guns, game controllers, touch pads, touch sticks, push buttons, optical sensors, microphones, webcams, and/or any other devices that can provide user input. Additionally, various input devices 166 may incorporate haptic technologies in order to provide feedback to the user. The client 106 may also have various output devices 169 such as, for example, audio devices, indicator lights, vibration devices, haptic devices, and so on.

The client 106 may be configured to execute various applications such as a client application 172 and/or other applications. The client application 172 may correspond to a browser that obtains and renders one or more network pages from the computing device 103 to facilitate selection and purchase of computing devices 112 and/or other items. Also, the client application 172 is executed to allow a user to interact with a computing device 112 or a virtual device instance 118. To this end, the client application 172 is configured to capture input commands provided by the user through one or more of the input devices 166 and send this input over the network 109 to the computing device 103 as device input data 122. The device input data 122 may also incorporate other data (e.g., GPS data, audio data, etc.) generated by the client 106 for use by the computing device 112 or the virtual device instance 118.

The client application 172 is also configured to obtain device output data 123 over the network 109 from the computing device 103 and render a screen 175 on the display 163. To this end, the client application 172 may include one or more video and audio players to play out a media stream corresponding to a virtual device instance 118 or a computing device 112. In one embodiment, the client application 172 comprises a plug-in or other client-side code executed within a browser application. The client 106 may be configured to execute applications beyond the client application 172 such as, for example, browser applications, email applications, instant message applications, and/or other applications. In some embodiments, multiple clients 106 may be employed for one or more users to interact with the virtual device instance 118 or the computing device 112. As non-limiting examples, some clients 106 may be specialized in display output, while other clients 106 may be specialized in obtaining user input. It is noted that different clients 106 may be associated with different latency requirements which may affect a delay employed before providing input commands to the virtual device instance 118 or the computing device 112.

Next, a general description of the operation of the various components of the networked environment 100 is provided. To begin, a customer at a client 106 browses a network site served up by the electronic commerce application 117. The customer may, for example, navigate a catalog taxonomy, execute a search query, select links, and/or perform other navigational functions. The customer may arrive at a detail network page or another similar network page that features a computing device 112 for purchase. Alternatively, the customer may have selected a computing device 112 and may be seeking to purchase applications 154, media files, etc. to be preloaded onto the computing device 112.

The customer may be given an opportunity to use the computing device 112 and/or application 127 through a simulated interface. To this end, the customer at the client 106 sends a request to launch an interactive remote access session to the server application 115. The server application 115 configures a computing device 112 or a virtual device instance 118 with a default device configuration 135 using the device configuration application 116. Alternatively, the customer may be able to return to a previously used device configuration 135 in a computing device 112 or a virtual device instance 118.

The virtual device instance 118 may provide a hosted environment for execution of applications 154. In some embodiments, the hosted environment may include a virtualized environment that virtualizes one or more resources of the computing device 103. Such resources may include exclusive resources, i.e., resources for which an application 154 requests exclusive access. For example, an application 154 may request full screen access from a video device, which is an exclusive resource because normally only one application can have full screen access. Furthermore, the virtual device instance 118 or the remote access application 154 may virtualize input devices such as, for example, keyboards, mice, GPS devices, accelerometers, etc. which may not actually be present in the computing device 103 or the computing device 112. The virtual device instance 118 may also provide access to a virtual file system to applications 154. In various embodiments, the virtual device instance 118 may correspond to a virtual machine and/or the virtual device instance 118 may be executed within a virtual machine.

The user at the client 106 enters input commands for the virtual device instance 118 or the remote access application 157 by use of the input devices 166 of the client 106. As a non-limiting example, the user may depress a left mouse button. Accordingly, the client application 172 functions to encode the input command into a format that may be transmitted over the network 109 within the device input data 122. The server application 115 receives the input command, adds it to the input queue 125 for the virtual device instance 118 or an input queue of the remote access application 157, and ultimately passes it to the virtual device instance 118 or the remote access application 157. The virtual device instance 118 or the remote access application 157 then provides a left mouse button depression to an application 154 by way of a virtualized mouse or an API call.

It is noted that variable latency characteristics of the network 109 may cause some input commands to be misinterpreted by the application 154 if the input commands are provided to the application 154 as soon as they are received. As a non-limiting example, two single clicks of a mouse button may be misinterpreted as a double click if the first single click is delayed by the network 109 by a greater amount than the second single click. Similarly, mouse clicks and mouse drags may be misinterpreted if the relative temporal relationship between certain input commands is not preserved.

As another non-limiting example, suppose that the application 154 corresponds to a game application within the fighting game genre, e.g., Mortal Kombat, Street Fighter, etc. The user at the client 106 may perform a series of complicated moves through a rapid sequence of input commands. If the input commands are subject to variable latency over the network 109, the series of moves may be misinterpreted by the application 154, thereby resulting in the character controlled by the user not performing the intended moves. For instance, two buttons may need to be pressed within a certain period of time to perform a punch move successfully. If the second input command is delayed by the network 109, but the first input command is not, the move may be unsuccessful without any fault of the user. To remedy this, the server application 154 may delay the first input command to preserve the relative temporal relationship between the first and second input commands. In so doing, the gesture, or command sequence, performed by the user is preserved for the application 154.

Although the additional delay used may be predetermined, it may also be calculated based on the difference between the time period between the commands when generated in the client 106 and the time period between when the commands are received by the server application 115. The time period between the commands when generated in the client 106 may be determined by referring to timestamps in metadata associated with the commands. It is noted that the various fixed latencies in the system (e.g., video encoding delay, minimum network latency) might not adversely impact the functionality of the application 154.

In some cases, the delay in providing the input command to the application 154 may depend at least in part on a video frame region that is associated with the input command. As a non-limiting example, with an application 154 that is a game, it may be important to delay an input command relating to game play to preserve the meaning of the input command. However, the game screen 145 may also include a chat window, and the input command may include text to be sent to another player in the game by way of the chat window. If the input command relates to the chat window, the virtual device instance 118 or remote access application 157 may be configured to provide the input command to the application 154 without additional delay. That is, it may be preferable to send the text to the other user as soon as possible. Accordingly, the delay may depend on whether the input command is related to the region of the screen 145 that is the chat window. Also, it is understood that an application 154 may have multiple modes, where one mode is associated with a delay in providing input commands while another is not.

It may also be important to ensure that the input command is synchronized with the video frame presented to the user on the screen 145 when the user generated the input command in the client 106. As a non-limiting example, because of the various latencies of the system, a fireball intended to be thrown by the character controlled by the user in a fighting game may be thrown later than intended. In some cases, this may not matter. For example, the user may merely want to throw the fireball, and a short delay in throwing the fireball may be perfectly acceptable to the user. However, for more precision, the application 154 may support an API that allows the virtual device instance 118 or remote access application 157 to associate a frame number or other temporal identifier with an input command. Therefore, the application 154 can know precisely when the input command was performed and react accordingly. The frame number or other temporal identifier may be sent to the server application 115 by the client application 172 as metadata for the input command.

In some embodiments, different input commands may be presented to the application 154 from those that were generated by a client 106. As a non-limiting example, if a user sends a mouse down command and the client application 172 loses focus, the virtual device instance 118 or remote access application 157 may be configured to send a mouse down command followed by a mouse up command. In various embodiments, the input commands may be relayed to the virtual device instance 118 or remote access application 157 as soon as possible, or the input commands may be queued by the virtual device instance 118 or remote access application 157 in the input queue 125 and relayed to the application 154 sequentially from the queue according to another approach.

Meanwhile, the graphical output of the virtual device instance 118 or the remote access application 157 is captured and encoded into a media stream. The graphical output may correspond to a video signal or another type of visual display. For example, the visual display may correspond to information about icons and coordinates where they are arranged. In another example, the graphical output corresponds to a sequence of images, which may be encoded into a Joint Photographic Experts Group (JPEG) media stream. Additionally, the audio output of virtual device instance 118 or remote access application 157 may be captured and multiplexed into the media stream. The graphical output and/or audio output may be captured by hardware devices of the computing device 103 or the computing device 112 in some embodiments. The media stream is transmitted by the server application 115 (or the remote access application 157) to the client 106 over the network 109 as the device output data 123. The client application 172 obtains the device output data 123 and renders a screen 145 on the display 142 in a user interface. The screen 145 may be surrounded by a device interface 133 generated from the corresponding device interface 133 that facilitates input and output for the computing device 112.

In some embodiments, a customer may start an interactive remote access session at one client 106 and continue the session at another client 106. Furthermore, multiple users at diverse locations may participate in an interactive remote access session. Various embodiments enable input generated through one type of input device 166 in a client 106 to be transformed by the virtual device instance 118 or remote access application 157 into input commands provided to the application 154 through an entirely different type of virtual input device. As a non-limiting example, input generated by an accelerometer in the client 106 may be translated by the virtual device instance 118 or remote access application 157 into input provided through a virtual mouse.

Where the input devices 148 incorporate haptic technologies and devices, force feedback may be provided to the output devices 169 within the device output data 123. As a non-limiting example, a simulated automobile steering wheel may be programmed by force feedback to give the user a feel of the road. As a user makes a turn or accelerates, the steering wheel may resist the turn or slip out of control. As another non-limiting example, the temperature of the input device 148 may be configured to change according to force feedback. In one embodiment, force feedback generated from the device input data 122 of one client 106 may be included in the device output data 123 sent to another client 106.

Having thoroughly tested and/or configured the computing device 112 with an interface that resembles the actual computing device 112, customers are well prepared to purchase the computing device 112. At any time, the customer may choose to purchase, lease, and/or download various applications 154 to the computing device 112 by selecting various purchase components in a network page. In some cases, the customer may select preconfigured bundles of applications 154 or other content that may be loaded onto the computing device 112. The customer may be billed by the electronic commerce application 117 as each of the applications 154 or other content are selected and loaded. Alternatively, the customer may be billed after potentially many applications 154 or other content are loaded and the device configuration 135 is finalized or replicated.

The customer may be able to save a device configuration 135 and modify the saved device configuration 135 in subsequent interactive remote access sessions. The device configuration application 116 may perform an error check on the modified device configuration 135 to ensure that it is valid. Once a customer has ended an interactive remote access session, the device configuration 135 of the virtual device instance 118 may be copied to a physical version of the computing device 112. Alternatively, if a physical computing device 112 is accessed remotely, changes to that computing device 112 may be maintained and/or replicated to other computing devices 112. Thereafter, the computing devices 112 including the potentially modified device configurations 135 may be shipped to the customer in fulfillment of an order. In some cases, the modified device configurations 135 may be replicated over the network 109 to one or more physical computing devices 112 already in possession of a customer, e.g., in a home or other environment.

Various techniques related to providing input commands to applications 154 that are executed remotely are described in U.S. patent application entitled “Sending Application Input Commands over a Network” filed on Dec. 15, 2010 and assigned application Ser. No. 12/968,845, and in U.S. patent application entitled “Remotely Emulating Computing Devices” filed on May 24, 2011 and assigned application Ser. No. 13/114,534, both of which are incorporated herein by reference in their entirety.

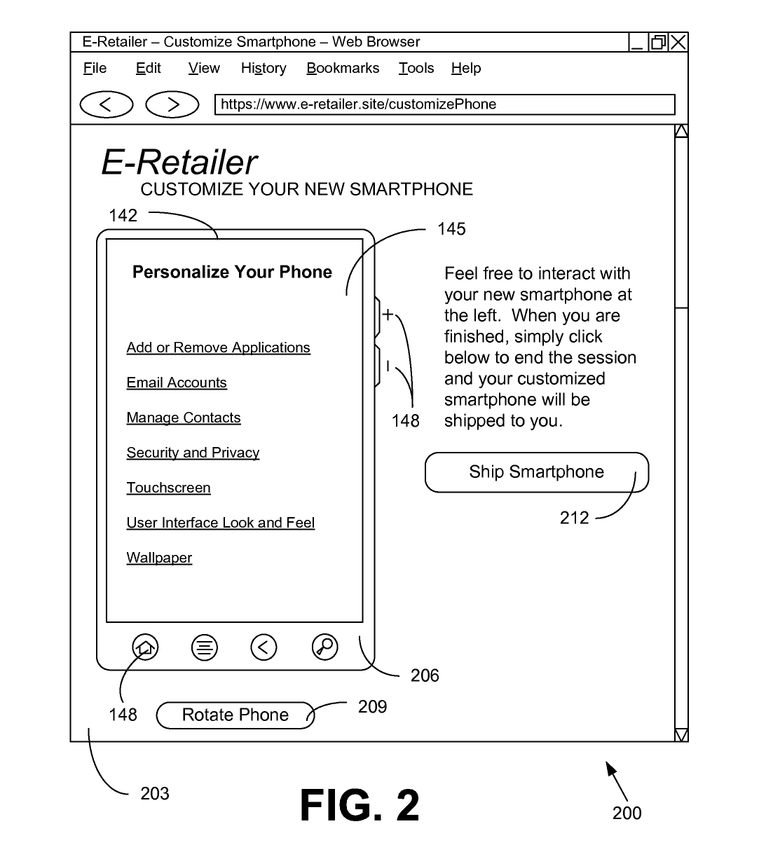

Moving on to FIG. 2, shown is an example of a user interface 200 rendered in a client 106 (FIG. 1) in the networked environment 100 (FIG. 1). The user interface 200 includes a network page 203 rendered by a client application 172 (FIG. 1) corresponding to a browser. The network page 203 includes a graphical representation 206 of the computing device 112 (FIG. 1) used for an interactive remote access session. The graphical representation 206 includes a display 142 on which a screen 145 is shown. The screen 145 corresponds to the media stream which is generated either by the remote access application 157 (FIG. 1) in an actual computing device 112 or from a visual display and/or audio signals generated by a virtual device instance 118 (FIG. 1) in the computing device 103 (FIG. 1). In other embodiments, the screen 145 is rendered without a surrounding graphical representation 206.

Various input devices 148 such as input buttons are represented by the graphical representation 206. The display 142 may correspond to a touchscreen. When a user interacts with the graphical representation 206, input data is sent to the server application 115 (FIG. 1). The input data may be translated into inputs for virtualized input devices of the virtual device instance 118 or inputs for actual input devices 148 or virtual input devices of the computing device 112. Additional controls 209 may be provided to generate input commands through performing an action relative to the graphical representation 206 of the computing device 112, e.g., rotating the graphical representation 206, which may then actuate an accelerometer or another type of input device 148.

The screen 145 depicts the graphical output of an application 154 (FIG. 1) for personalizing the computing device 112, which is in this case a smartphone. Various actions may be performed such as, for example, adding or removing applications 154, managing email accounts, managing contacts, configuring security and privacy settings, configuring a touchscreen, configuring the look and feel of a user interface, setting wallpaper, installing a bundle or suite of applications 154 such as a productivity suite, and so on. In one example, a user may wish to remove unwanted applications 154 from a default device configuration 135. The user is able to interact with the computing device 112 (or virtual version thereof), which results in a changed device configuration 135. In other words, applications 154 may be configured or installed, files may be uploaded or modified, and so on. Although screen 145 depicts a particular personalization application 154, it is understood that the customer may interact with the computing device 112 in any way through the operating system or other applications 154.

A session end control 212 may be provided to end the session and/or continue with a purchase of the preconfigured computing device 112. In this example, the session end control 212 is labeled “ship smartphone.” When the session end control 212 is selected, the interactive user session with the computing device 112 is ended, and a computing device 112 with the modified configuration is readied for shipment.

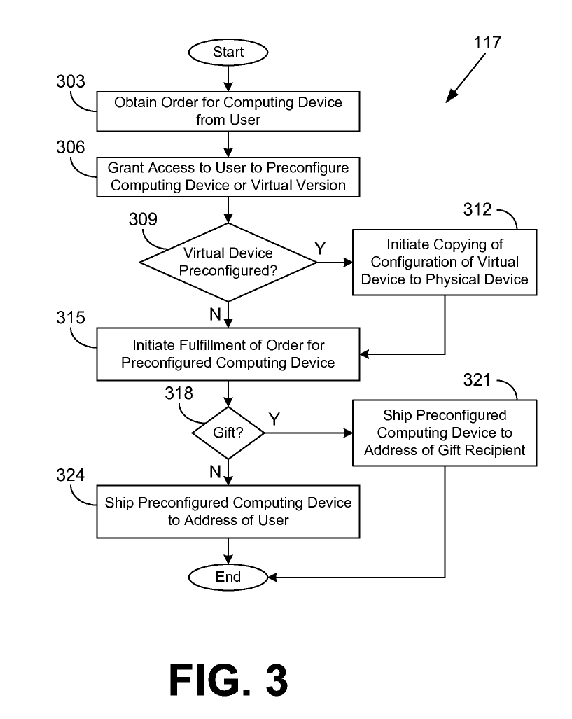

Referring next to FIG. 3, shown is a flowchart that provides one example of the operation of a portion of the electronic commerce application 117 according to various embodiments. It is understood that the flowchart of FIG. 3 provides merely an example of the many different types of functional arrangements that may be employed to implement the operation of the portion of the electronic commerce application 117 as described herein. As an alternative, the flowchart of FIG. 3 may be viewed as depicting an example of steps of a method implemented in the computing device 103 (FIG. 1) according to one or more embodiments.

Beginning with box 303, the electronic commerce application 117 obtains an order for a computing device 112 (FIG. 1) from a user at a client 106 (FIG. 1). In box 306, the electronic commerce application 117 grants access to the user to preconfigure or otherwise use the computing device 112 or a virtual device instance 118 (FIG. 1) corresponding to a virtualized version of the computing device 112. In other embodiments, the user may be given access to the computing device 112 or the virtual device instance 118 before the user places an order. As part of granting access, the computing device 112 or the virtual device instance 118 may be preconfigured by the device configuration application 116 (FIG. 1) with a default configuration. Subsequently, the user may access the virtual device instance 118 or the computing device 112 by way of a user interface served up by the server application 115 (FIG. 1).

In box 309, the electronic commerce application 117 determines whether a virtual device instance 118 has been preconfigured. If a virtual device instance 118 has been preconfigured, the electronic commerce application 117 initiates a copying or replicating of the device configuration 135 (FIG. 1) of the virtual device instance 118 to a physical computing device 112 in box 312. The electronic commerce application 117 then proceeds to box 315. If a virtual device instance 118 has not been preconfigured, the same computing device 112 preconfigured by the user may be shipped to the user. Alternatively, the device configuration 135 of the preconfigured computing device 112 may be copied to another computing device 112. Thereafter, the electronic commerce application 117 also proceeds from box 309 to box 315.

In box 315, the electronic commerce application 117 initiates fulfillment of the order by the user for the preconfigured computing device 112. For example, the preconfigured computing device 112 may be decoupled from the network 109 and physically packed for shipment. In box 318, the electronic commerce application 117 determines whether the preconfigured computing device 112 is a gift. If the preconfigured computing device 112 is a gift, the electronic commerce application 117 continues to box 321 and initiates a shipment of the order to an address of a gift recipient specified by the user in the user data 137 (FIG. 1). Thereafter, the portion of the electronic commerce application 117 ends. Otherwise, if the preconfigured computing device 112 is not a gift, the electronic commerce application 117 proceeds to box 324 and initiates a shipment of the order to an address of the user specified in the user data 137. Thereafter, the portion of the electronic commerce application 117 ends.

Although FIG. 3 relates to shipment of preconfigured computing devices 112, it is understood that computing devices 112 may be updated after receipt by a customer with a customized device configuration 135 created following the principles of the present disclosure. For example, a device configuration 135 may be downloaded by way of the network 109 (FIG. 1) and then adopted by a computing device 112. Such actions may be taken automatically when the computing device 112 is first powered on and connected to the network 109 in one embodiment. Furthermore, a customized device configuration 135 may be replicated to any number of computing devices 112 as desired.

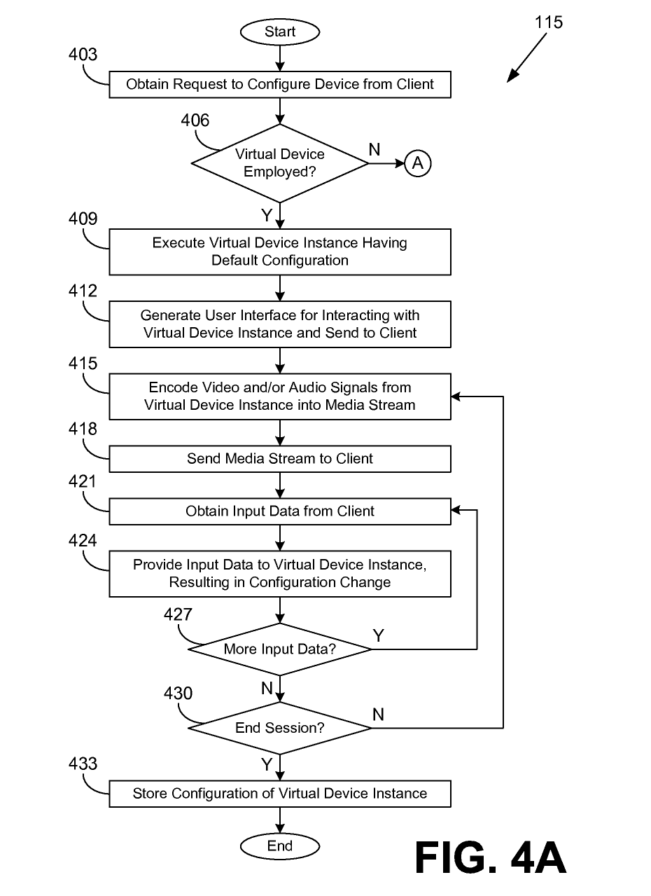

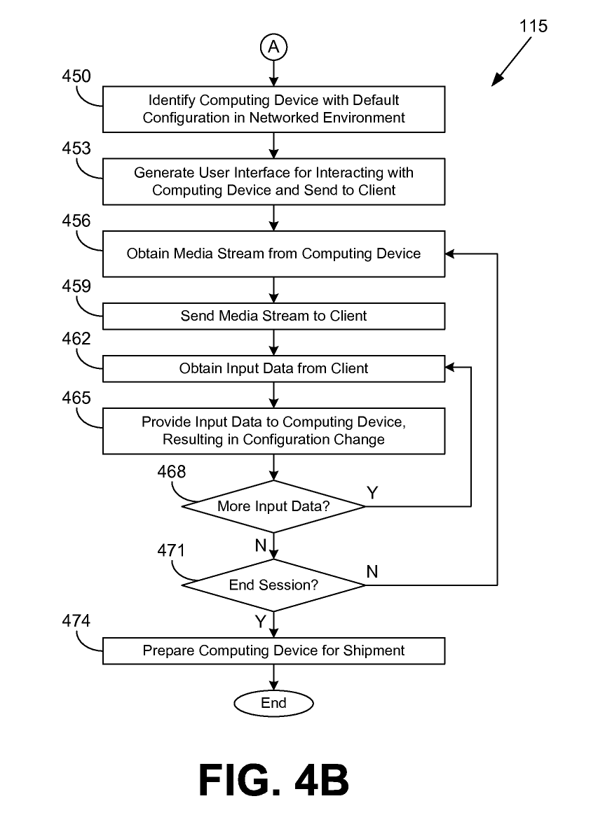

Turning now to FIGS. 4A and 4B, shown is a flowchart that provides one example of the operation of a portion of the server application 115 according to various embodiments. It is understood that the flowchart of FIGS. 4A and 4B provides merely an example of the many different types of functional arrangements that may be employed to implement the operation of the portion of the server application 115 as described herein. As an alternative, the flowchart of FIGS. 4A and 4B may be viewed as depicting an example of steps of a method implemented in the computing device 103 (FIG. 1) according to one or more embodiments.

Beginning with box 403 of FIG. 4A, the server application 115 obtains a request to configure a computing device 112 (FIG. 1) from a user at a client 106 (FIG. 1). The user may have purchased the computing device 112 to be preconfigured, or the user may want to test out the computing device 112 in contemplation of a purchase. The request may be accepted or denied based on whether the user has authorization. In box 406, the server application 115 determines whether a virtual device instance 118 (FIG. 1) is to be employed for the user to have access. If not, the server application 115 proceeds to FIG. 4B. If a virtual device instance 118 is to be employed, the server application 115 instead continues from box 406 to box 409.

In box 409, the server application 115 executes the virtual device instance 118 having the default device configuration 135 (FIG. 1). In box 412, the server application 115 generates a user interface for interacting with the virtual device instance 118. The server application 115 then sends the user interface to the client 106. In one embodiment, the user interface includes a graphical representation of the computing device 112 as generated from a device interface 133 (FIG. 1). In box 415, the server application 115 encodes video and/or audio signals generated by the virtual device instance 118 into a media stream using a media encoder 120 (FIG. 1).

In box 418, the server application 115 sends the media stream to the client 106 through the network 109 (FIG. 1). In box 421, the server application 115 obtains input data from the client 106. In box 424, the server application 115 provides the input data to the virtual device instance 118. At least a portion of the input data results in a change to the device configuration 135 of the virtual device instance 118. In box 427, the server application 115 determines whether more input data is forthcoming from the client 106. If more input data is forthcoming, the server application 115 returns to box 421 and obtains the input data from the client 106.

If no more input data is forthcoming, the server application 115 instead proceeds to box 430 and determines whether the session is to be ended. If the session is not to be ended, the server application 115 returns to box 415 and continues to encode the media stream. If the session is to be ended, the server application 115 proceeds from box 430 to box 433. In box 433, the server application 115 stores the device configuration 135 of the virtual device instance 118, which has been preconfigured, customized, or personalized by the user. Thereafter, the portion of the server application 115 ends.

If a virtual device instance 118 is not to be employed, the server application 115 proceeds from box 406 to box 450 of FIG. 4B. In box 450, the server application 115 identifies a computing device 112 having a default device configuration 135 in the networked environment 100. If no computing device 112 has the default configuration, the server application 115 may initiate a copying of a default device configuration 135 to one of the computing devices 112 by the device configuration application 116 (FIG. 1).

In box 453, the server application 115 generates a user interface for interacting with the computing device 112. The server application 115 then sends the user interface to the client 106. In one embodiment, the user interface includes a graphical representation of the computing device 112 as generated from a device interface 133. In box 456, the server application 115 obtains a media stream from the computing device 112.

In box 459, the server application 115 sends the media stream to the client 106 through the network 109. In box 462, the server application 115 obtains input data from the client 106. In box 465, the server application 115 provides the input data to the computing device 112. At least a portion of the input data results in a change to the device configuration 135 of the computing device 112. In box 468, the server application 115 determines whether more input data is forthcoming from the client 106. If more input data is forthcoming, the server application 115 returns to box 462 and obtains the input data from the client 106.

If no more input data is forthcoming, the server application 115 instead proceeds to box 471 and determines whether the session is to be ended. If the session is not to be ended, the server application 115 returns to box 456 and continues to obtain the media stream. If the session is to be ended, the server application 115 proceeds from box 471 to box 474. In box 474, the server application 115 prepares the computing device 112 for shipment. For example, the server application 115 may gracefully shutdown the computing device 112. Thereafter, the portion of the server application 115 ends.

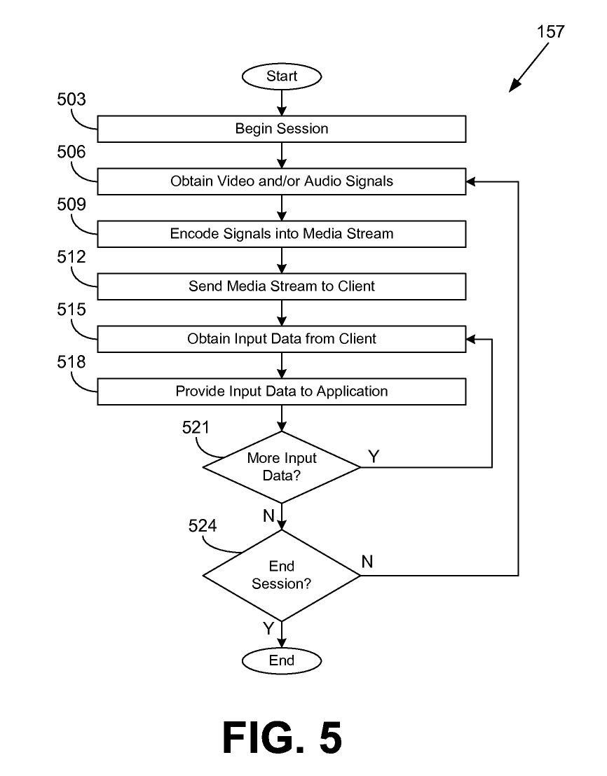

Continuing on to FIG. 5, shown is a flowchart that provides one example of the operation of a portion of the remote access application 157 according to various embodiments. It is understood that the flowchart of FIG. 5 provides merely an example of the many different types of functional arrangements that may be employed to implement the operation of the portion of the remote access application 157 as described herein. As an alternative, the flowchart of FIG. 5 may be viewed as depicting an example of steps of a method implemented in the computing device 112 (FIG. 1) according to one or more embodiments.

Beginning with box 503, the remote access application 157 begins an interactive session with a user at a client 106 (FIG. 1). In one embodiment, the remote access application 157 communicates directly with the client 106. In another embodiment, the remote access application 157 communicates with the client 106 by way of the server application 115. In box 506, the remote access application 157 obtains a video signal and/or an audio signal generated by the computing device 112. In box 509, the remote access application 157 encodes the video signal and/or audio signal into a media stream using a media encoder 120 (FIG. 1). In box 512, the remote access application 157 sends the media stream to the client 106.

In box 515, the remote access application 157 obtains input data from the client 106. In box 518, the remote access application 157 provides the input data to one or more applications 154 (FIG. 1) executed in the computing device 112. At least a portion of the input data may effect a change to a device configuration 135 (FIG. 1) of the computing device 112. In box 521, the remote access application 157 determines whether more input data is to be obtained.

If more input data is to be obtained, the remote access application 157 returns to box 515 and obtains input data from the client 106. If more input data is not to be obtained, the remote access application 157 continues to box 524. In box 524, the remote access application 157 determines whether the session is to be ended. If the session is not to be ended, the remote access application 157 returns to box 506 and continues obtaining video and/or audio signals. Otherwise, the portion of the remote access application 157 ends.

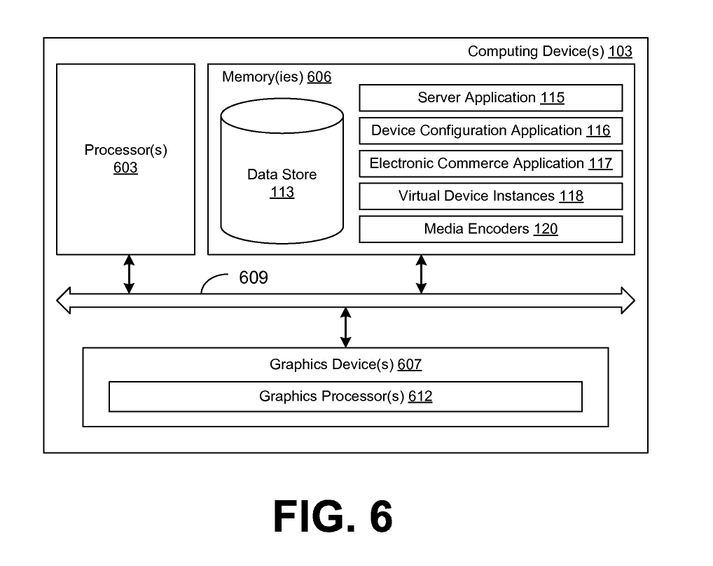

With reference to FIG. 6, shown is a schematic block diagram of the computing device 103 according to an embodiment of the present disclosure. The computing device 103 includes at least one processor circuit, for example, having a processor 603, a memory 606, and one or more graphics devices 607, all of which are coupled to a local interface 609. To this end, the computing device 103 may comprise, for example, at least one server computer or like device. The local interface 609 may comprise, for example, a data bus with an accompanying address/control bus or other bus structure as can be appreciated. The graphics devices 607 may correspond to high-performance graphics hardware, including one or more graphics processors 612. The graphics devices 607 are configured to render graphics corresponding to the virtual device instances 118 executed in the computing device 103.

Stored in the memory 606 are both data and several components that are executable by the processor 603. In particular, stored in the memory 606 and executable by the processor 603 are the server application 115, the device configuration application 116, the electronic commerce application 117, the virtual device instances 118, the media encoders 120, and potentially other applications. Also stored in the memory 606 may be a data store 113 and other data. In addition, an operating system may be stored in the memory 606 and executable by the processor 603.

It is understood that there may be other applications that are stored in the memory 606 and are executable by the processors 603 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Delphi®, Flash®, or other programming languages.

A number of software components are stored in the memory 606 and are executable by the processor 603. In this respect, the term “executable” means a program file that is in a form that can ultimately be run by the processor 603. Examples of executable programs may be, for example, a compiled program that can be translated into machine code in a format that can be loaded into a random access portion of the memory 606 and run by the processor 603, source code that may be expressed in proper format such as object code that is capable of being loaded into a random access portion of the memory 606 and executed by the processor 603, or source code that may be interpreted by another executable program to generate instructions in a random access portion of the memory 606 to be executed by the processor 603, etc. An executable program may be stored in any portion or component of the memory 606 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 606 is defined herein as including both volatile and nonvolatile memory and data storage components. Volatile components are those that do not retain data values upon loss of power. Nonvolatile components are those that retain data upon a loss of power. Thus, the memory 606 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 603 may represent multiple processors 603 and the memory 606 may represent multiple memories 606 that operate in parallel processing circuits, respectively. In such a case, the local interface 609 may be an appropriate network 109 (FIG. 1) that facilitates communication between any two of the multiple processors 603, between any processor 603 and any of the memories 606, or between any two of the memories 606, etc. The local interface 609 may comprise additional systems designed to coordinate this communication, including, for example, performing load balancing. The processor 603 may be of electrical or of some other available construction.

Although the server application 115, the device configuration application 116, the electronic commerce application 117, the virtual device instances 118, the media encoders 120, the applications 154 (FIG. 1), the remote access application 157 (FIG. 1), the client application 172 (FIG. 1), and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowcharts of FIGS. 3-5 show the functionality and operation of an implementation of portions of the electronic commerce application 117, the server application 115, and the remote access application 157. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 603 in a computer system or other system. The machine code may be converted from the source code, etc. If embodied in hardware, each block may represent a circuit or a number of interconnected circuits to implement the specified logical function(s).

Although the flowcharts of FIGS. 3-5 show a specific order of execution, it is understood that the order of execution may differ from that which is depicted. For example, the order of execution of two or more blocks may be scrambled relative to the order shown. Also, two or more blocks shown in succession in FIGS. 3-5 may be executed concurrently or with partial concurrence. Further, in some embodiments, one or more of the blocks shown in FIGS. 3-5 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the server application 115, the device configuration application 116, the electronic commerce application 117, the virtual device instances 118, the media encoders 120, the applications 154, the remote access application 157, the client application 172, that comprises software or code can be embodied in any non-transitory computer-readable medium for use by or in connection with an instruction execution system such as, for example, a processor 603 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A non-transitory computer-readable medium embodying a program executable in a computing device, the program comprising:
code that executes a virtualized version of a computing device;
code that encodes a video signal and an audio signal generated by the virtualized version of the computing device into a media stream;
code that generates a user interface that includes a graphical representation of the computing device, wherein a screen of the graphical representation is configured to show the video signal of the media stream; and
code that sends the user interface and the media stream to the client;
code that obtains input data from a user at the client and provides the input data to the virtualized version of the computing device, wherein at least a portion of the input data effects a change to a configuration of the virtualized version of the computing device;
code that obtains an order for the physical version of the computing device from the user at the client;
code that initiates a copying of the configuration of the virtualized version of the computing device to the physical version of the computing device, the configuration being adopted by the physical version of the computing device; and
code that initiates a shipment of the physical version of the computing device to an address associated with the user.

2. A system, comprising:
at least one computing device; and
at least one application executable in the at least one computing device, the at least one application comprising:
logic that executes a virtualized version of a computing device;
logic that encodes a visual display generated by the virtualized version of the computing device into a media stream and sends the media stream to a client;
logic that obtains input data from the client and provides the input data to the virtualized version of the computing device, wherein at least a portion of the input data effects a change to a configuration of the virtualized version of the computing device; and
logic that initiates a copying of the configuration of the virtualized version of the computing device to a physical version of the computing device, the configuration being adopted by the physical version of the computing device.

3. The system of claim 2, wherein the visual display is a video signal.

4. The system of claim 2, wherein the at least one application further comprises logic that encodes an audio signal generated by the virtualized version of the computing device into the media stream.

5. The system of claim 2, wherein the change to the configuration corresponds to a change to a configuration of an application executed in the virtualized version of the computing device.

6. The system of claim 2, wherein the change to the configuration corresponds to an installation of an application in the virtualized version of the computing device.

7. The system of claim 6, wherein the at least one application further comprises logic that facilitates a purchase of the application relative to the installation.

8. The system of claim 2, wherein the change to the configuration corresponds to an installation of a suite of applications in the virtualized version of the computing device.

9. The system of claim 2, wherein the change to the configuration corresponds to a removal of an application in the virtualized version of the computing device.

10. The system of claim 2, wherein the change to the configuration corresponds to an upload of at least one file to the virtualized version of the computing device.

11. The system of claim 2, wherein the at least one application further comprises:
logic that obtains an order for the physical version of the computing device from a user; and
logic that facilitates access by the user to the virtualized version of the computing device in response to the order.

12. The system of claim 2, wherein the at least one application further comprises:
logic that obtains an order for the physical version of the computing device from a user after the user at the client has effected the change to the configuration of the virtualized version of the computing device; and
wherein the logic that initiates is configured to initiate the copying of the configuration in response to the order.

13. The system of claim 2, wherein the at least one application further comprises logic that initiates fulfillment of an order by a user for the physical version of the computing device.

14. The system of claim 2, wherein the at least one application further comprises:
logic that generates a user interface that includes a graphical representation of the computing device, wherein a screen of the graphical representation is configured to show the visual display of the media stream; and
logic that sends the user interface to the client.

15. A method, comprising the steps of:
obtaining, in at least one computing device, a visual display generated by a computing device corresponding to a screen of the computing device;
encoding, in the at least one computing device, the visual display into a media stream;
sending, in the at least one computing device, the media stream to a client;
obtaining, in the at least one computing device, input data from a user at the client;
providing, in the at least one computing device, the input data to the computing device, at least a portion of the input data effecting a change to a configuration of the computing device; and
initiating, in the at least one computing device, fulfillment of an order by the user for the computing device having the configuration that is changed.

16. The method of claim 15, wherein the change corresponds to an installation of an application.

17. The method of claim 15, further comprising the step of maintaining, in the at least one computing device, a plurality of the computing device in a networked environment.

18. The method of claim 15, further comprising the steps of:
generating, in the at least one computing device, a user interface that includes a graphical representation of the computing device, wherein a screen of the graphical representation is configured to show the visual display of the media stream; and
sending, in the at least one computing device, the user interface to the client.

19. The method of claim 18, wherein the graphical representation of the computing device includes a graphical representation of an input device, the graphical representation of the input device being configured to generate at least a portion of the input data in response to being graphically selected by the user at the client.

20. The method of claim 15, further comprising the step of replicating, in the at least one computing device, the configuration that is changed to another computing device, wherein the configuration that is changed is adopted by the other computing device.

21. The method of claim 15, wherein the step of initiating, in the at least one computing device, fulfillment of the order further comprises the step of initiating, in the at least one computing device, a shipment of the computing device having the configuration that is changed to an address associated with the user.

22. The method of claim 21, wherein the order corresponds to a gift by the user to a gift recipient, and the address corresponds to the gift recipient.

23. The method of claim 15, further comprising the step of copying, in the at least one computing device, a default configuration to the computing device.

24. The method of claim 15, further comprising the steps of:
obtaining, in the at least one computing device, the order from the user; and
granting, in the at least one computing device, remote access by the user to the computing device in response to the order.

25. The method of claim 15, further comprising the steps of:
granting, in the at least one computing device, remote access by the user to the computing device before the order is obtained;
obtaining, in the at least one computing device, the order from the user; and
wherein the fulfillment of the order is initiated in response to obtaining the order.
